(19) United States
(12) Patent Application Publication
(10) Pub. No.: US 2012/0036643 A1
(43) Pub. Date: Feb. 16, 2012

(54) Pillow having speakers

(75) Inventors: Michael Howard Giles, Silver Spring, MD (US); Julian Michael Giles, Silver Spring, MD (US); Taelor Nicole Giles, Silver Spring, MD (US)

(73) Assignee: Perceptive Concepts Unlimited, LLC, Silver Spring, MD (US)

(21) Appl. No.: 12/805,635

(22) Filed: Aug. 11, 2010

(51) Int. Cl. A47G 9/10; H04R 1/02

(52) U.S. Cl. 5/652

(57) ABSTRACT

A pillow according has an ornamental display on a top side, a main cushioning portion, and speakers. The ornamental display has speaker holding protrusions that protrude from the pillow and hold the speakers.

### BACKGROUND OF THE INVENTION

1. Field of the Invention

The present invention generally relates to a pillow. More specifically, the present invention relates to a pillow having at least one speaker.

2. Background Information

Pillows with speakers have been known in the prior art. Specifically, pillows having speakers embedded or removable inserted into pillows are known. For example, U.S. Pat. Nos. 7,627,917, 6,044,161, 5,201,002, and 5,123,133 all disclose a pillow having speakers. The pillows have a speaker disposed inside the main portion or body of the pillow. However, since the placement of the speakers is inside the body of the pillow, a user cannot enjoy the maximal effect of the speakers because their placement is generally at the rear of the head or behind the ears. Folding a pillow around his ears to maximize the effect of the speakers defeats one of the purposes of a pillow, namely relaxation. U.S. Pat. No. 6,044,161 discloses a head receiving cavity with the speakers arranged in the cavity, but such a cavity would tend to limit head movement with regards to enjoying the maximal effect of the speakers.

Further, conventional pillows with speakers embedded therein lack ornamental designs that would enhance their beauty and make them more desirable for users.

Thus, there exists a need for a pillow with speakers that maximize listening enjoyment and relaxation for a user. There also exists a need for a pillow with speakers with an improved ornamental design.

In view of the above, it will be apparent to those skilled in the art from this disclosure that there exists a need for an improved pillow having speakers. This invention addresses this need in the art as well as other needs, which will become apparent to those skilled in the art from this disclosure.

### SUMMARY

A pillow according to a first aspect has an ornamental display on a top side, a main cushioning portion, speaker holding protrusions, and speakers. The speaker holding protrusions protrude from the pillow and hold the speakers.

A pillow according to another aspect has an ornamental display on a top side, a main cushioning portion, and speakers embedded in the cushioning portion.

These and other objects, features, aspects, and advantages of the present invention will become apparent to those skilled in the art from the following detailed description, which, taken in conjunction with the annexed drawings, discloses exemplary embodiments of the present invention.

### BRIEF DESCRIPTION OF THE DRAWINGS

Referring now to the attached drawings which form a part of this original disclosure:

FIGS. 1 and 1a are plan views of pillows in accordance with an exemplary embodiment;

FIG. 2 is an elevational view of the pillow of FIG. 1 as seen from the rear;

FIG. 3 is a right side elevational view of the pillow of FIG. 1;

FIG. 4 is a left side elevational view of the pillow of FIG. 1;

FIG. 5 is an elevation view of the pillow of FIG. 1 as seen from the front;

FIG. 6 is a schematic view of the pillow of FIG. 1 illustrating parts in the interior thereof;

FIG. 7 is a bottom plan view of the pillow of FIG. 1;

FIGS. 8-11b are views of pillows having various designs in accordance with a modification;

FIG. 12 is a view of the pillow of FIG. 1 being employed by a user;

FIG. 13 is an elevational view of the pillow of FIG. 10 as seen from the rear;

FIG. 14 is a right side elevational view of the pillow of FIG. 10;

FIG. 15 is a left side elevational view of the pillow of FIG. 10;

FIG. 16 is an elevation view of the pillow of FIG. 10 as seen from the front;

FIG. 17 is a schematic view of the pillow of FIG. 10 illustrating parts in the interior of the pillow;

FIG. 18 is a bottom plan view of the pillow of FIG. 10;

FIGS. 19-22 are plan views of pillows in accordance with an alternate embodiment; and

FIG. 23 is a schematic view of the pillow of FIG. 19 illustrating parts in the interior of the pillow in accordance with the alternate embodiment.

### DETAILED DESCRIPTION OF THE EXEMPLARY EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

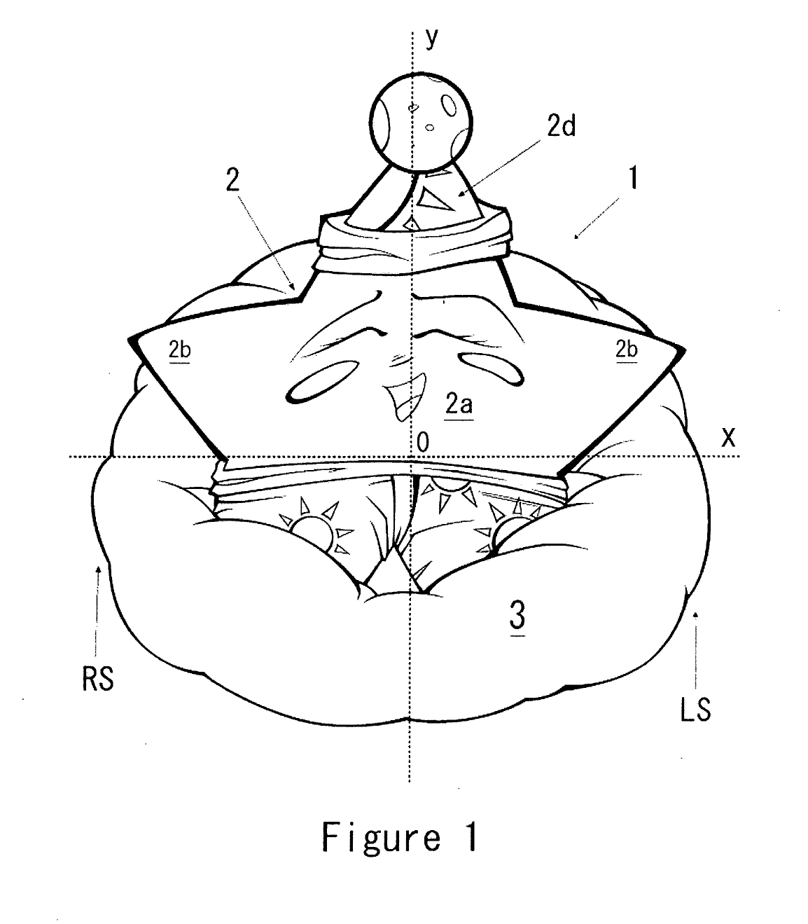

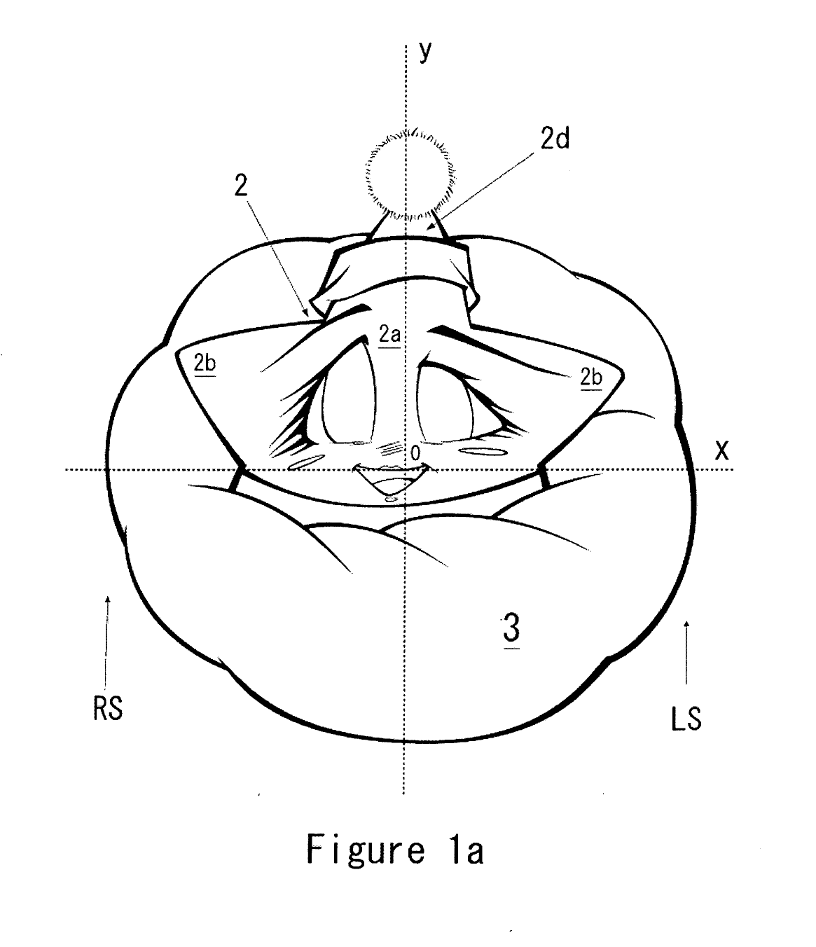

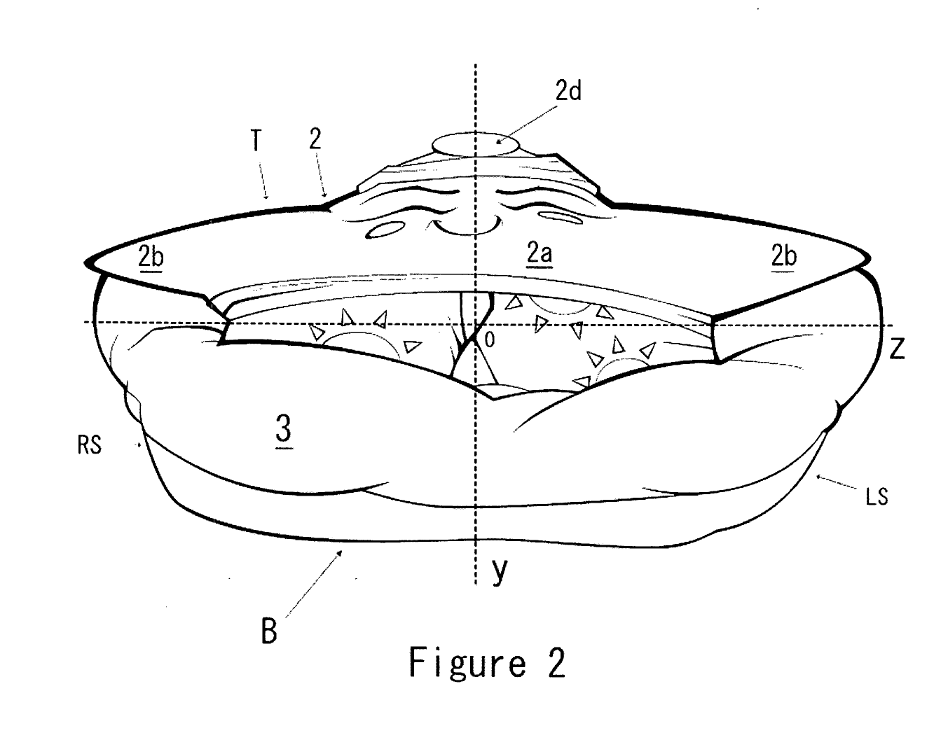

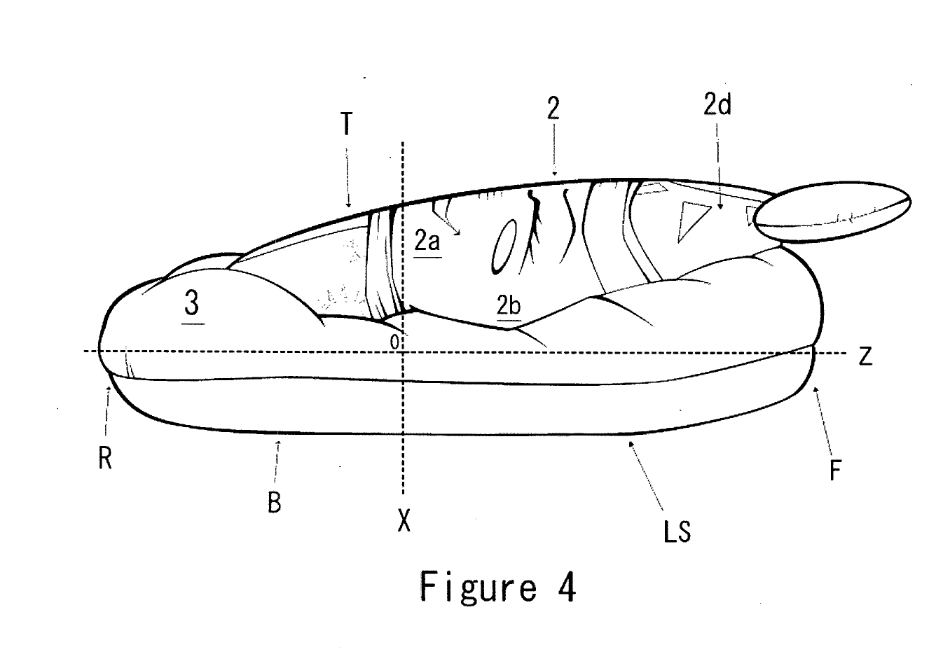

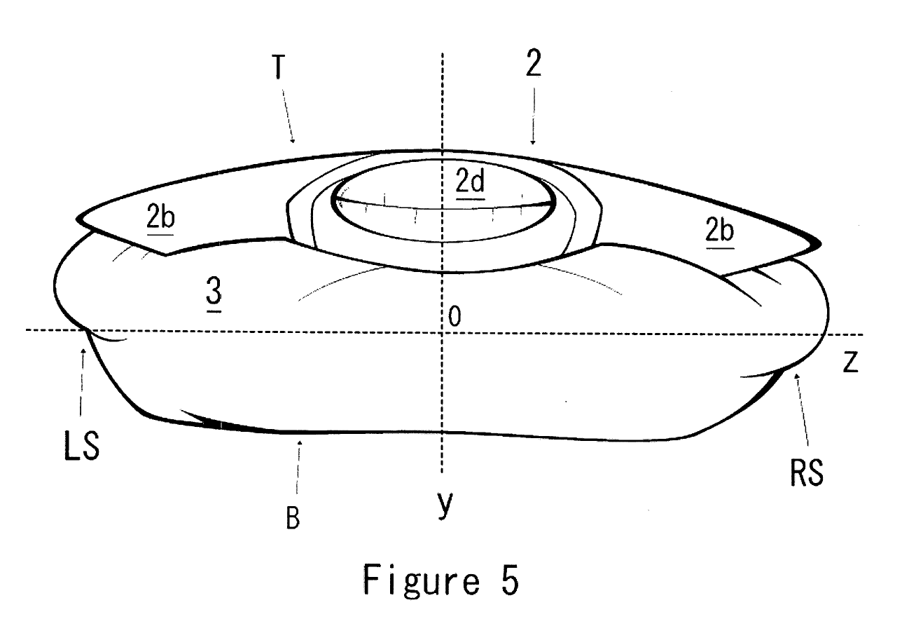

Referring initially to FIG. 1, a pillow 1 is illustrated in accordance with a first embodiment. As seen in FIGS. 2-5, the pillow 1 has top T, bottom B, a front F, a rear R, a left side LS, and a right side RS joining the top T to the bottom B and the front F to the rear R. The general shape of the pillow can be any suitable shape. Referring to FIGS. 1-5, the pillow 1 can be divided by bisecting planes that intersect at the center of the pillow 1. A first bisecting plane x extends from the left side LS to the right side RS and the top T to the bottom B. The first bisecting plane x bisects the pillow 1 at a point that is at a distance halfway or substantially halfway between the front F to the rear R. A second bisecting plane y extends perpendicularly to the first bisecting plane x, and more specifically extends from the top T to the bottom B and the front F to the rear R. The second bisecting plane y bisects the pillow 1 at a point that is at a distance halfway or substantially halfway between the left side LS and the right side RS. A third bisecting plane z extends perpendicularly to both the first and second bisecting planes x and y, and more specifically extends from the front F to the rear R and the left side LS to the right side RS. The third bisecting plane z bisects the pillow 1 at a point that is a distance that is halfway or substantially halfway between the top T and the bottom B on the rear R. The third bisecting plane z extends parallel or substantially parallel to bottom B of the pillow 1 if the bottom B is flat, or parallel or substantially parallel to the major axis or diameter of the bottom B if the bottom B is rounded or circular. Each bisecting plane x, y, and z is perpendicular to the other two planes. The center 0 is the point at which all three planes x, y, and z intersect.

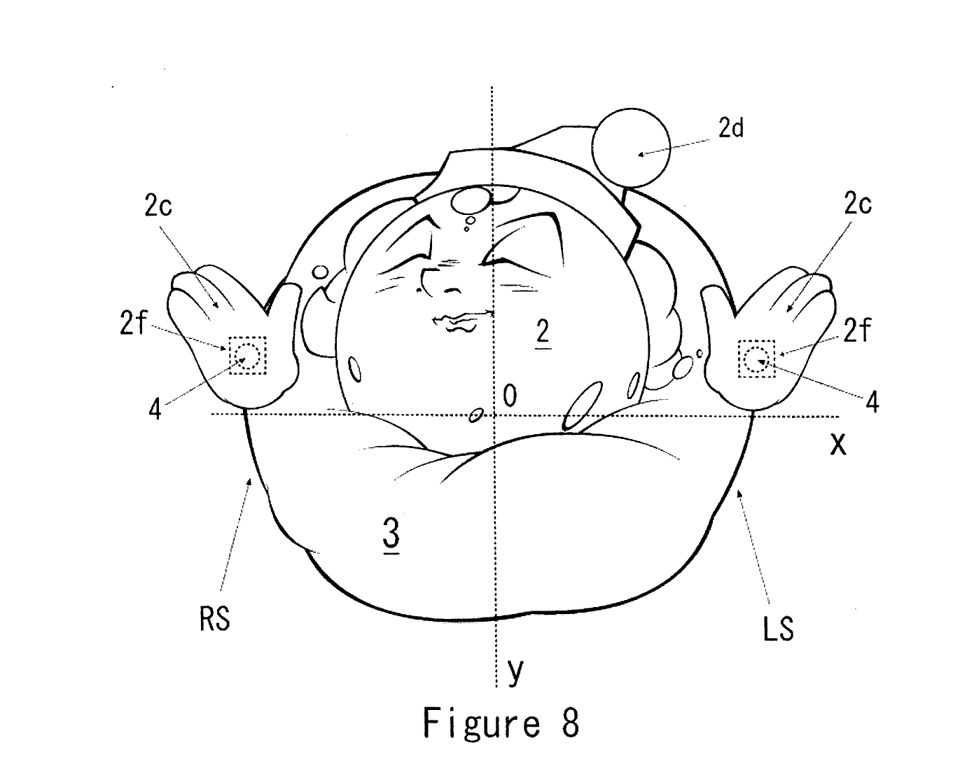

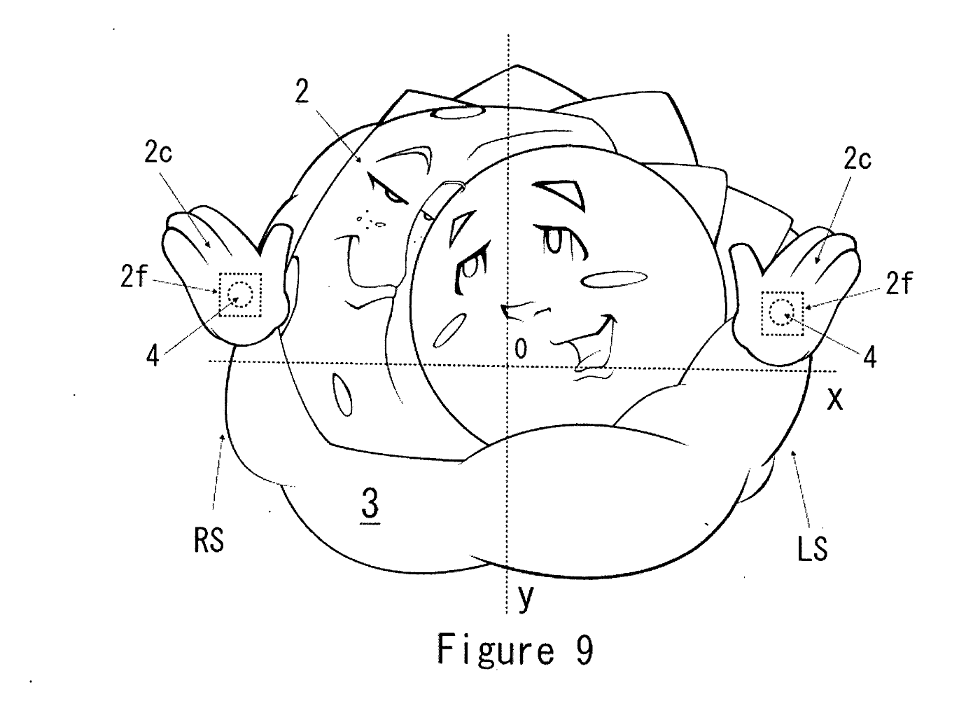

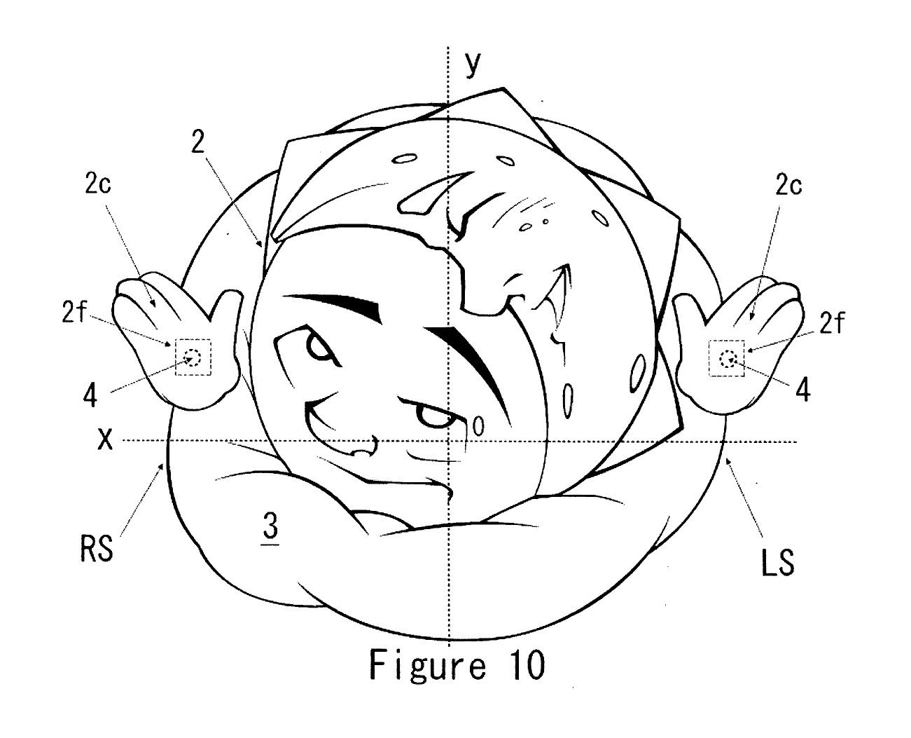

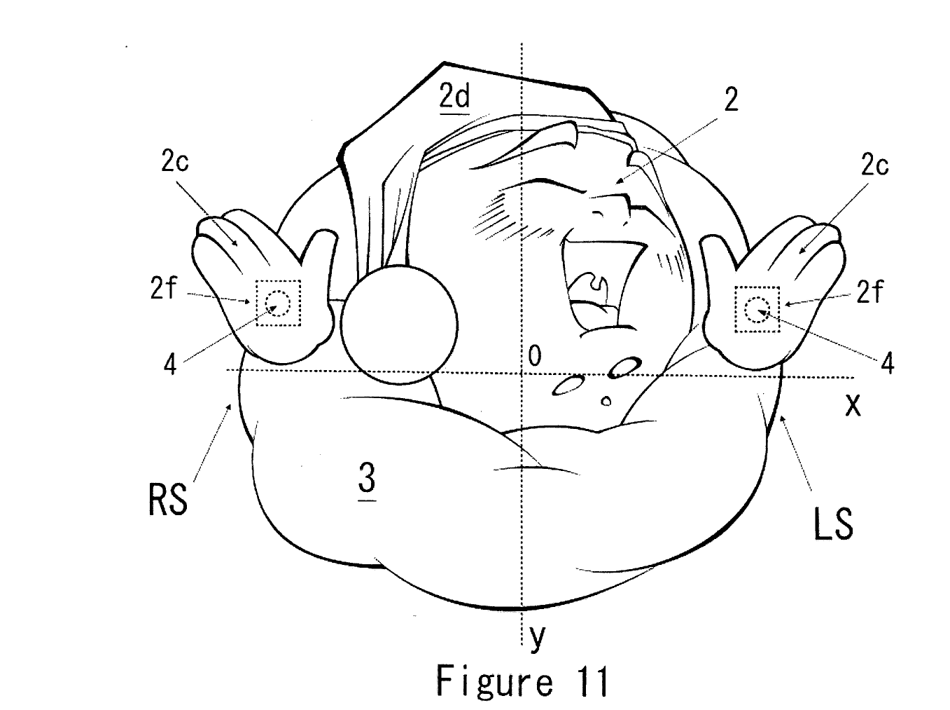

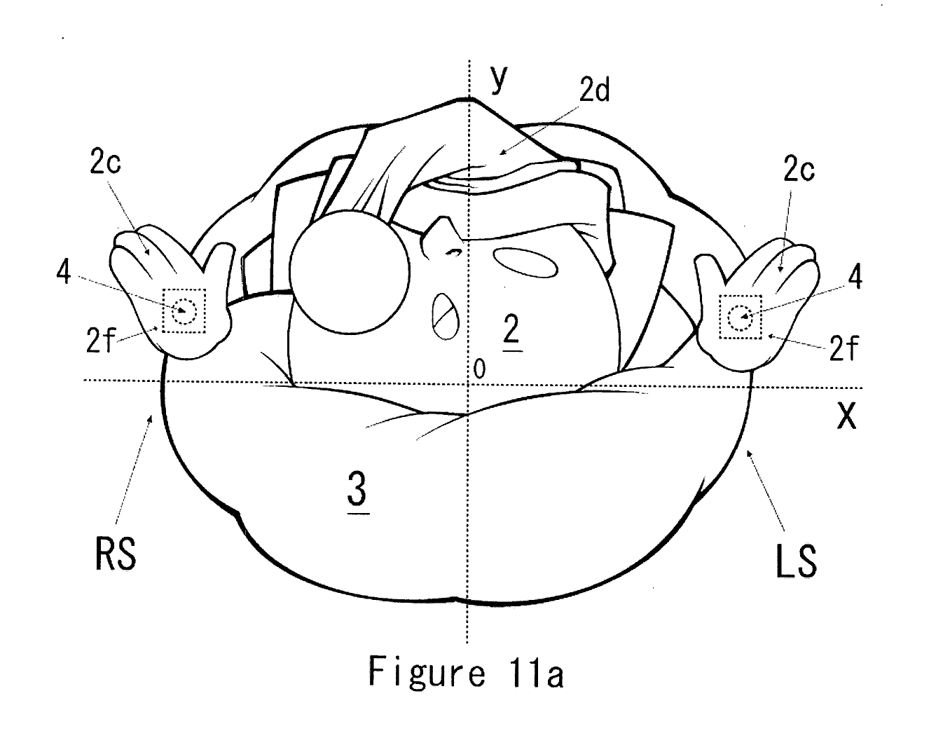

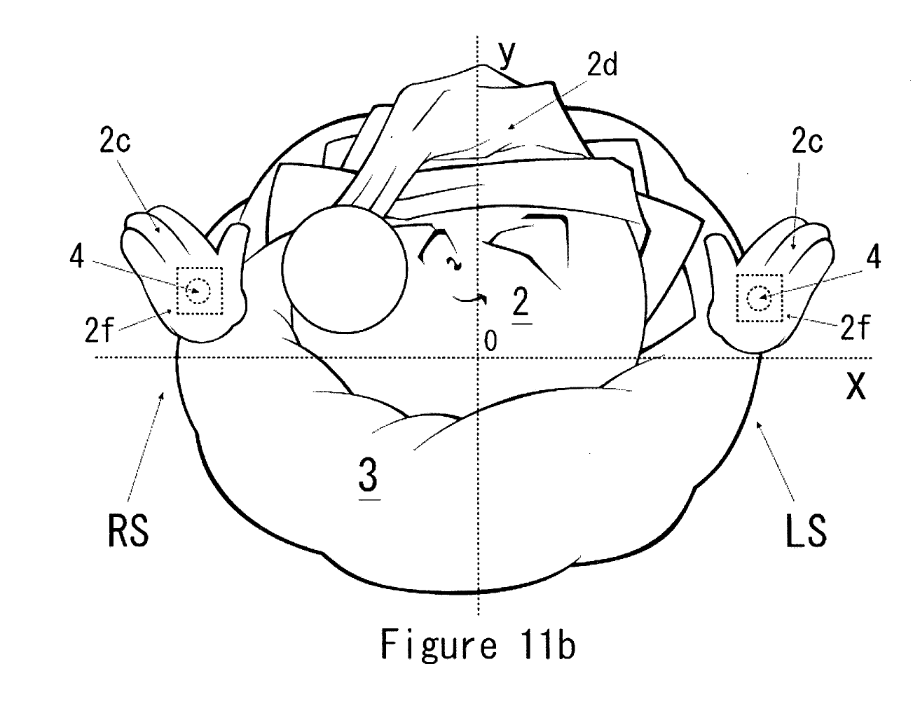

The pillow 1 has an ornamental display 2 located on and protruding from a top side thereof and a main cushioning portion 3 located below the ornamental display 2. The ornamental display 2 can be any suitable display, preferably an anthropomorphized inanimate object or objects, more preferably a celestial anthropomorphized inanimate object or objects, and most preferably an anthropomorphized star, sun, moon, cloud, or a combination thereof. The ornamental display 2 has a front side, lateral sides, and can have a rear side. The rear side of the ornamental display 2 connects to and extends from the main cushioning portion 3 so that the interiors of the ornamental display 2 and main cushioning portion 3 communicate with each other. The ornamental display 2 can have eyes, a mouth, a nose, and eyebrows. As seen in FIG. 1, the ornamental display 2 has a main portion 2a, and arms 2b extending from the main portion 2a to opposite sides of the main portion 2a. Alternatively, as seen in FIG. 8, the ornamental display 2 can have hands 2c extending from the main cushioning portion 3 on opposite sides of the ornamental display 2 separate therefrom. The arms 2b or the hands 2c are examples of speaker holding protrusions that protrude from the pillow 1 and hold speakers 4 (described below). Similar to the ornamental display 2 of FIG. 1, each of the hands 2c has a front side, a rear side, lateral sides, and a back side extending from the main cushioning portion 3. The ornamental display 2 can also have a head covering 2d. The head covering 2d can be any suitable covering, and is preferably a hat, and more preferably a night cap.

The arms 2b are located on the front side of the first bisecting plane x and the top side of the third bisecting plane z. One arm 2b extends outward from the main portion 2a on a left side of the second bisecting plane y, and the other arm 2b extends outward from the main portion 2a on a right side of the second bisecting plane y. As seen in FIG. 8, alternatively, the hands 2c can be located on the first bisecting plane x and the top side of the third bisecting plane z. One hand 2c extends outward from the main cushioning portion 3 on a left side of the second bisecting plane y, and the other hand 2c extends outward from the main cushioning portion 3 on a right side of the second bisecting plane y.

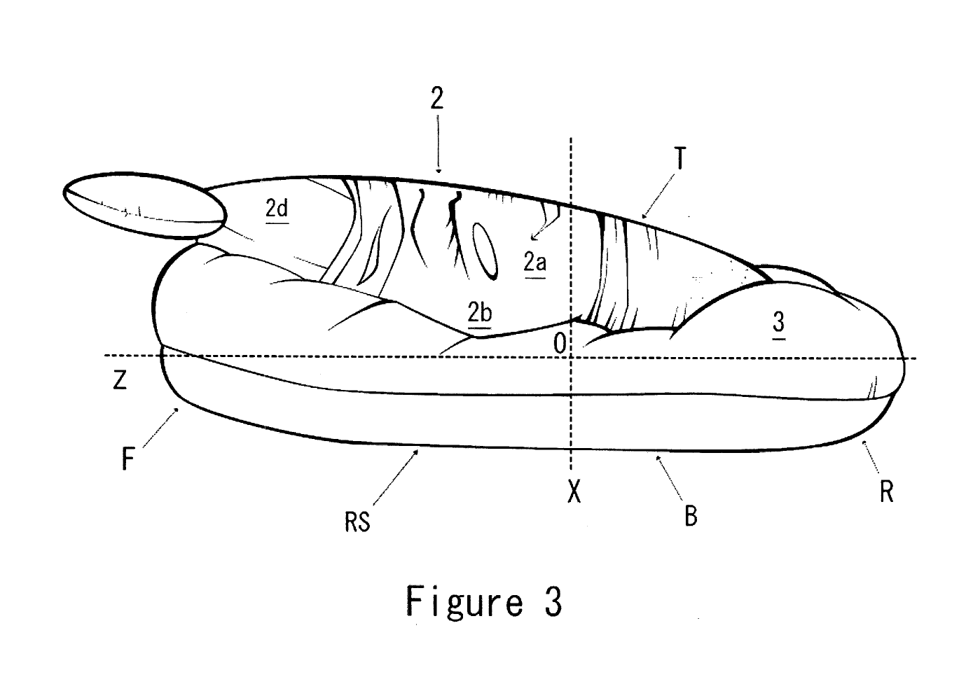

As seen in FIG. 3, the top surface of the ornamental display 2 is arranged to incline upward from the rear R to the front F to the first bisecting plane x increasing the distance from the bottom B to the top T. On the front side of the first bisecting plane x, the surface continues to incline upward before tapering toward the bottom B. The top surface of the front end of the ornamental display 2 is separated by a distance from the bottom B that is greater than a distance that separates the top surface of the rear end of the ornamental display 2 and the bottom B, with the distances being parallel to the first bisecting plane x and each other. This configuration applies when no weight is resting on the ornamental display 2 and the interior of the pillow 1 is full or substantially full and not pre-compressed.

Further, the top surface of the ornamental display 2 from the left side LS to the right side RS is designed to arc upward reaching its highest point at or near the second bisecting plane y. Alternatively, the ornamental display 2 can be flat or concave in this direction. These configurations apply when no weight is resting on the ornamental display 2 and the interior of the pillow 1 is full or substantially full and not pre-compressed.

The ornamental display 2, main cushioning portion 3, and arms 2b form a one piece unitary member. Alternatively, the ornamental display 2, main cushioning portion 3, and hands 2c form a one piece unitary member.

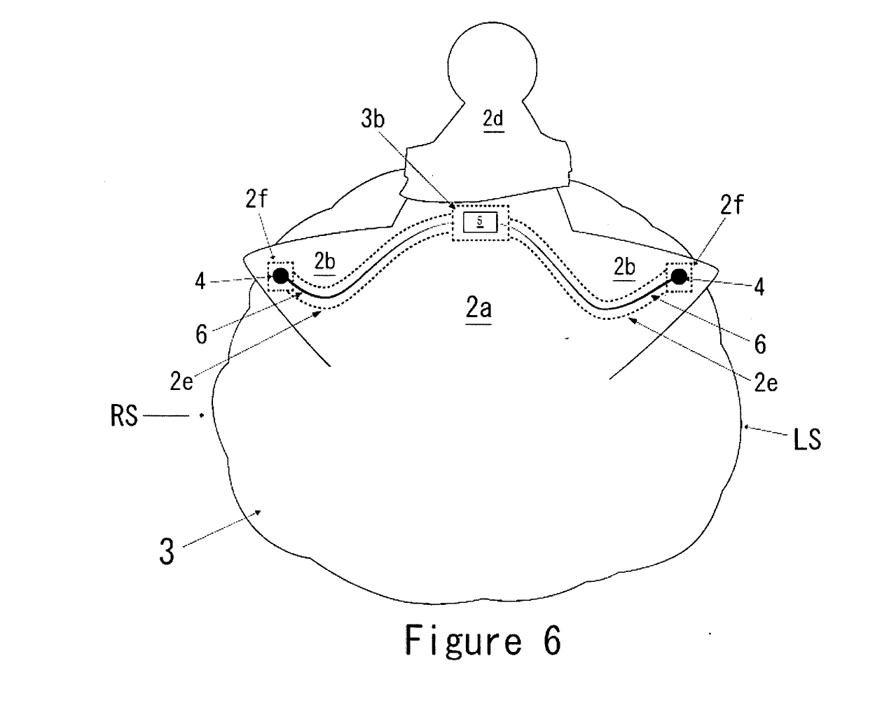

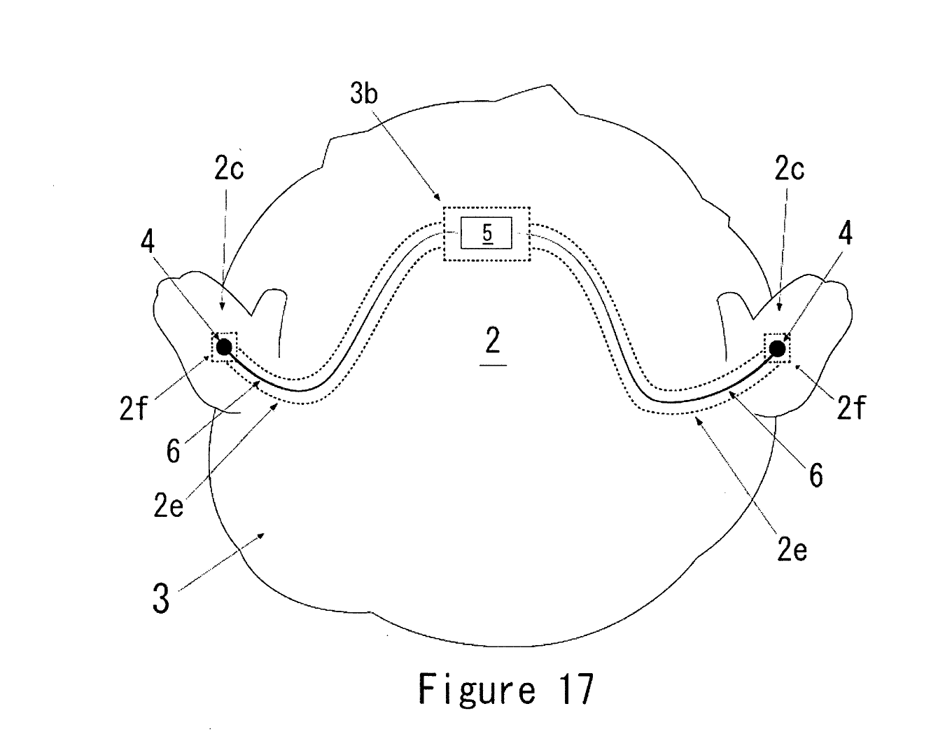

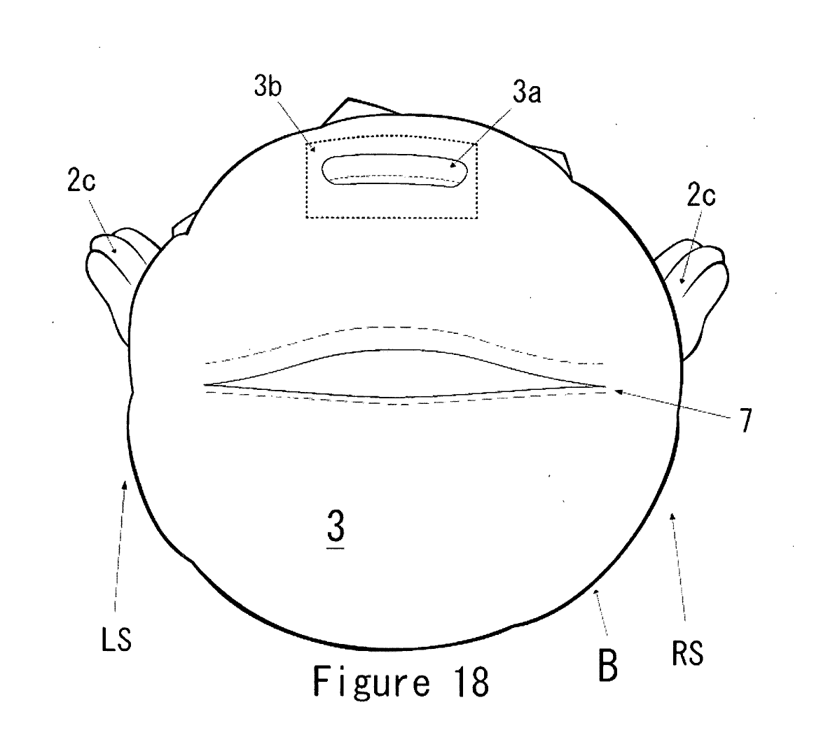

At least two speakers 4 are located in the pillow 1. As seen in FIGS. 6 and 17, the speakers 4 are located in the arms 2b or hands 2c of the ornamental display 2. The speakers 4 are connected to an audio device 5 by wires 6. The wires 6 extend from the speakers 4 to the audio device 5 via wiring tunnels 2e. The wires 6 are detachably connected to the audio device 5. The speakers 4 are located in speaker compartment chambers 2f located in the arms 2b or hands 2c of the ornamental display 2. Each speaker compartment 2f covers or surrounds its respective speaker 4 with a material that separates it from cushioning material located in the interior of the pillow 1. A portion of each speaker chamber is arranged to have an open portion that cannot be covered by cushioning material and is attached to the interior portion opposite the top surface of the arms 2b or hands 2c.

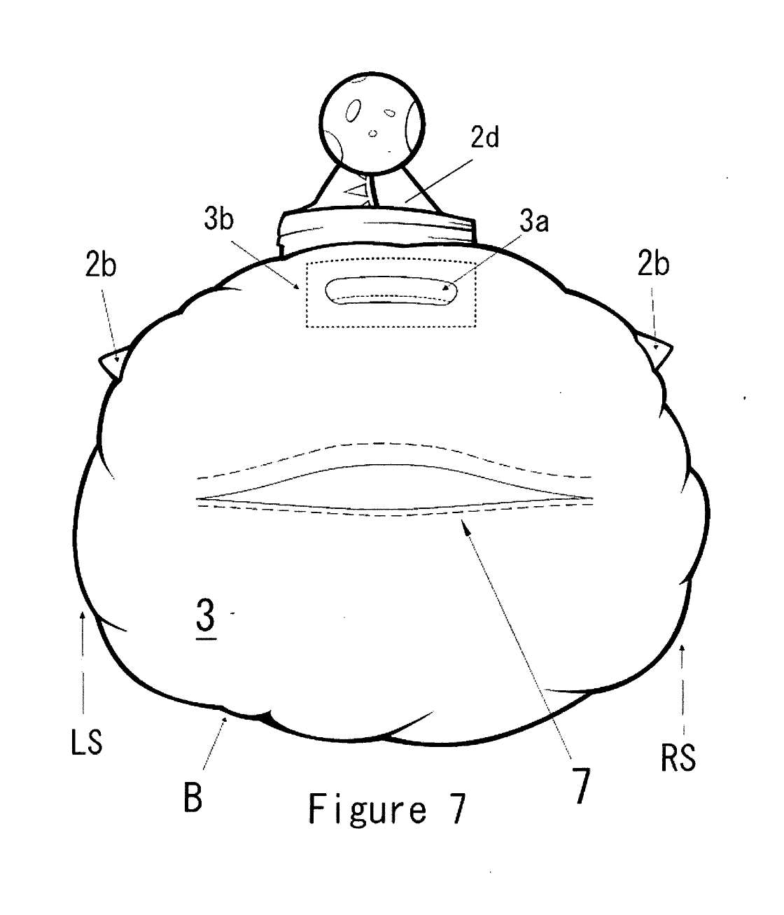

The audio device 5 is located in the main cushioning portion 3 below the ornamental display 2. As seen in FIG. 7, the main cushioning portion 3 has an audio device hatch 3a located therein. The audio device hatch 3a can be located in the bottom of the main cushioning portion 3. The audio device hatch 3a opens and closes an audio device compartment 3b that can house the audio device 5 to allow for installation and removal of the audio device 5 in the pillow 1. When closed, the audio device hatch 3a and the audio device compartment 3b surround the audio device 5 with a material that separates it from cushioning material located in the interior main cushioning portion 3 of the pillow 1.

The wiring tunnels 2e extend from the speaker compartment 2f to the audio device compartment 3b. The wiring tunnels 2e surround the wires 6 with a material that separates it from cushioning material in the interior of the pillow 1. The wiring tunnel 2e material can be a cloth, plastic, or other suitably flexible material.

As seen in FIG. 7, the pillow 1 has an opening 7 located on the front side of the first axis x and the bottom side of the third axis z. The opening can be selectively opened and closed to remove and to insert cushioning material in the interior of the pillow 1.

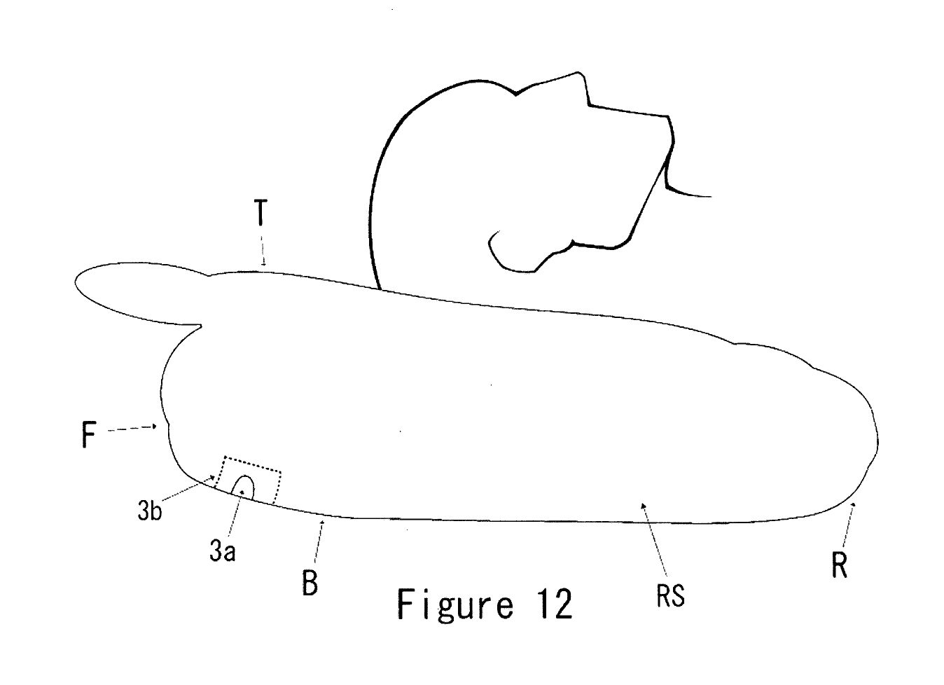

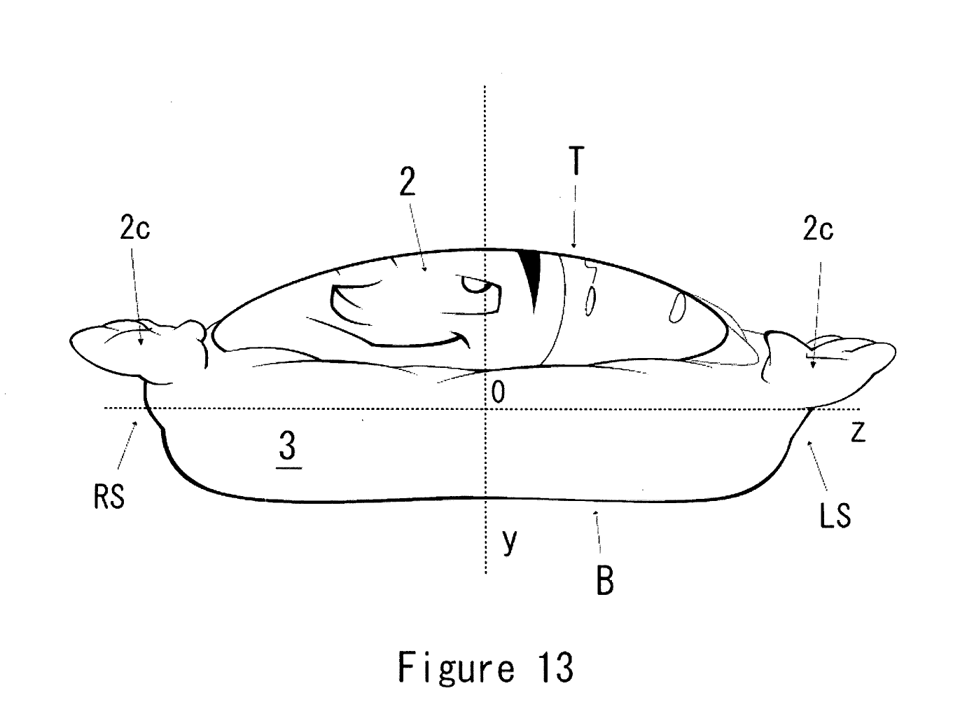

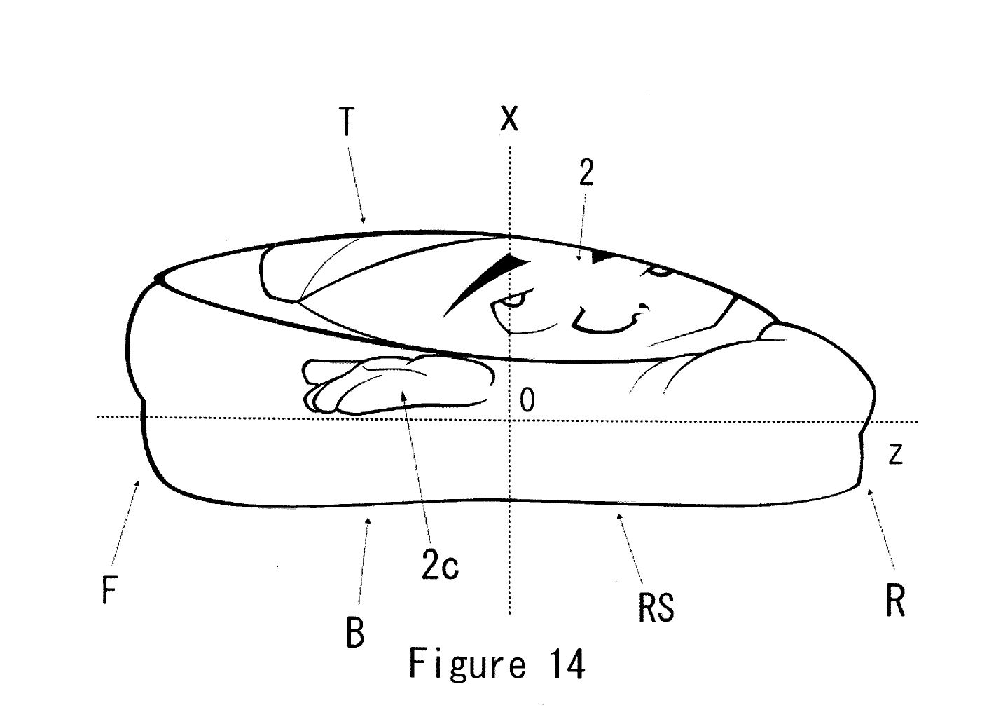

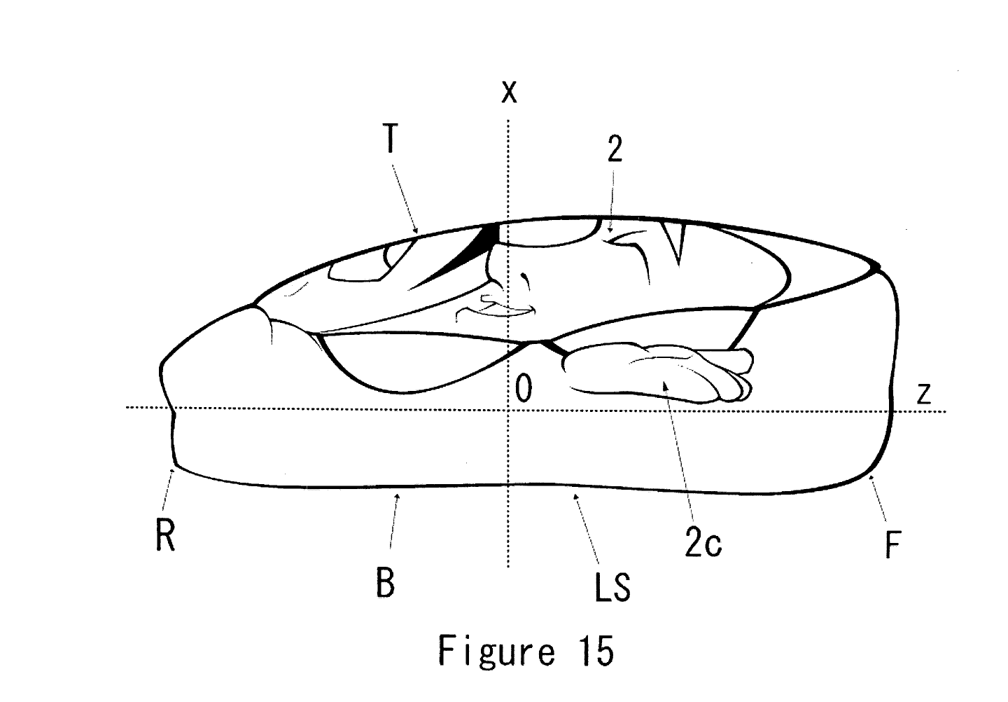

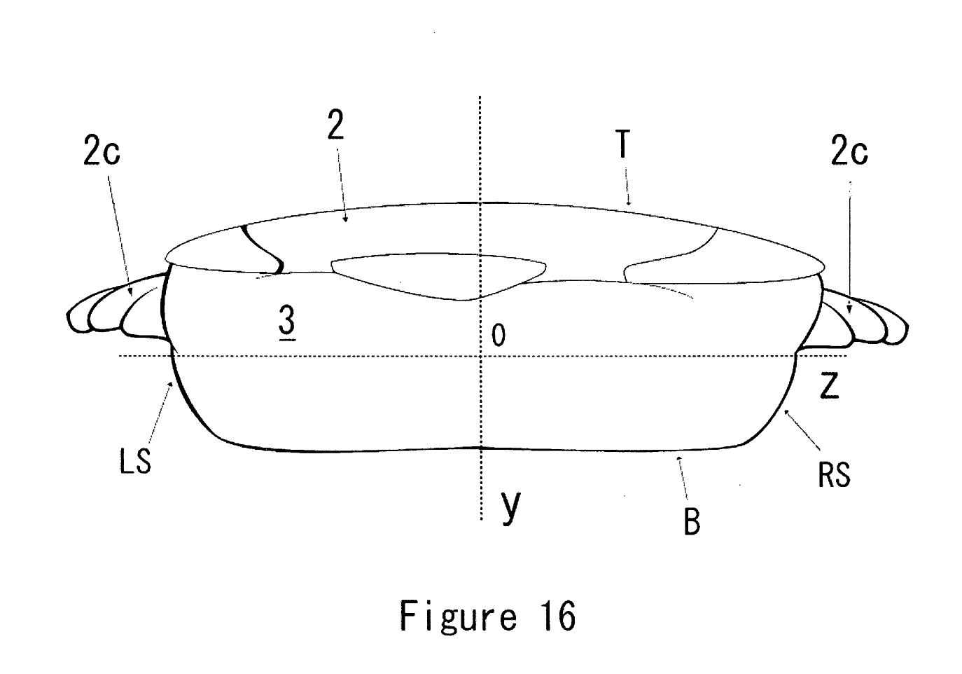

As seen in FIG. 12, a user can rest his head on the pillow 1 and listen to audio emanating from the speakers 4. Since the speakers 4 are located on opposite sides of the pillow 1, a user can hear sound broadcast in stereo. Further, the speakers can be set to have sound restrictions via a control unit.

Although this embodiment utilized hands and arms in which to house speakers, it should be apparent from this disclosure that other appendages or parts could be used such as ears, eyes, and the like.

### Alternate Embodiment

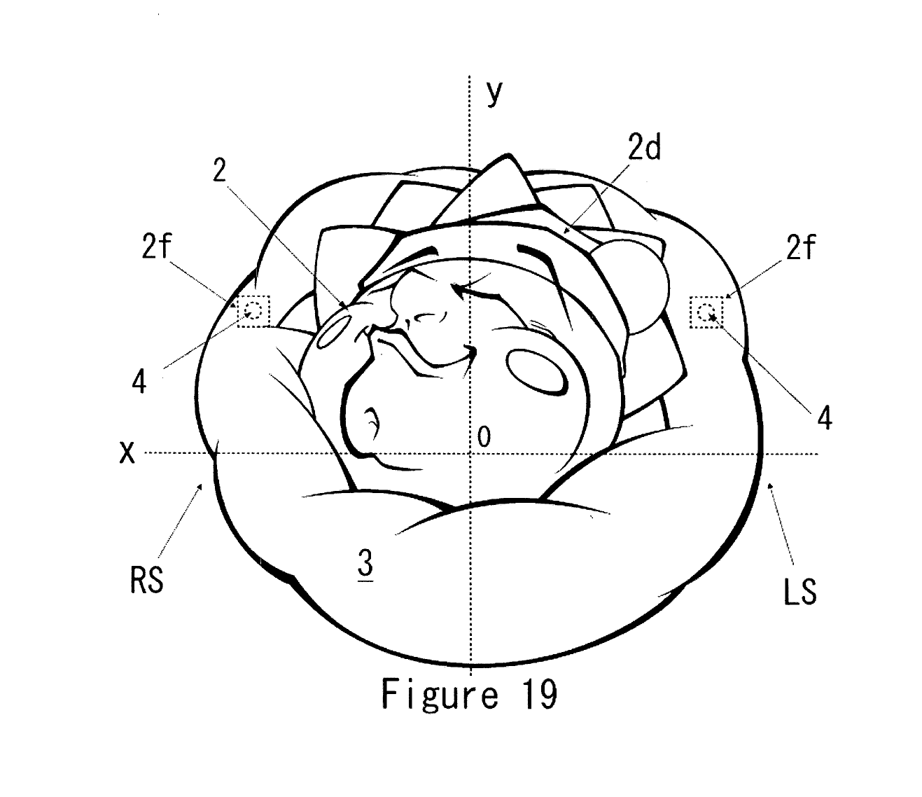

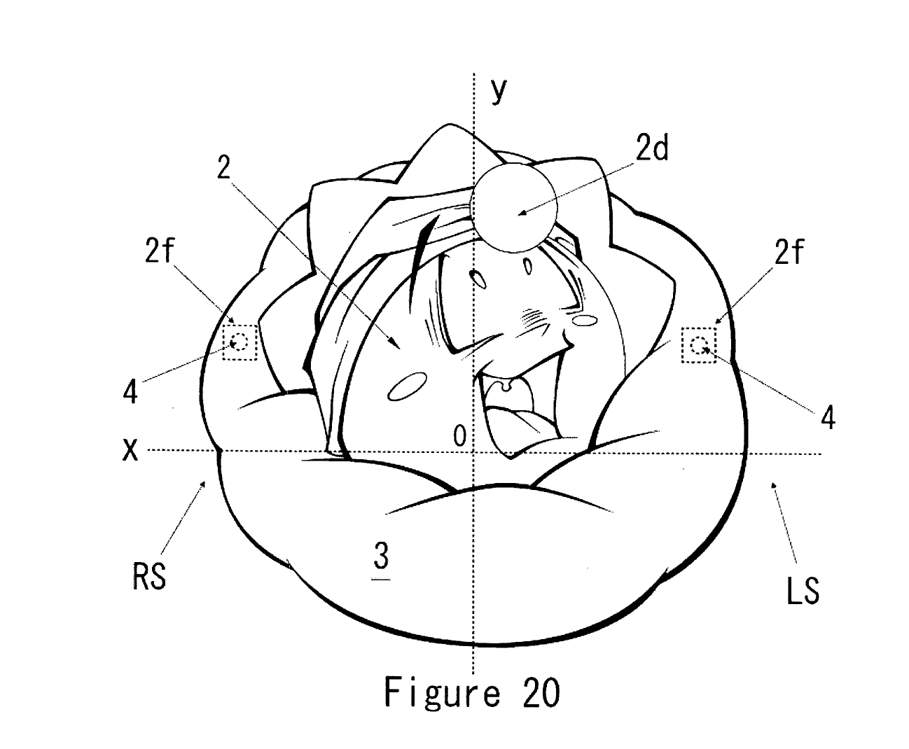

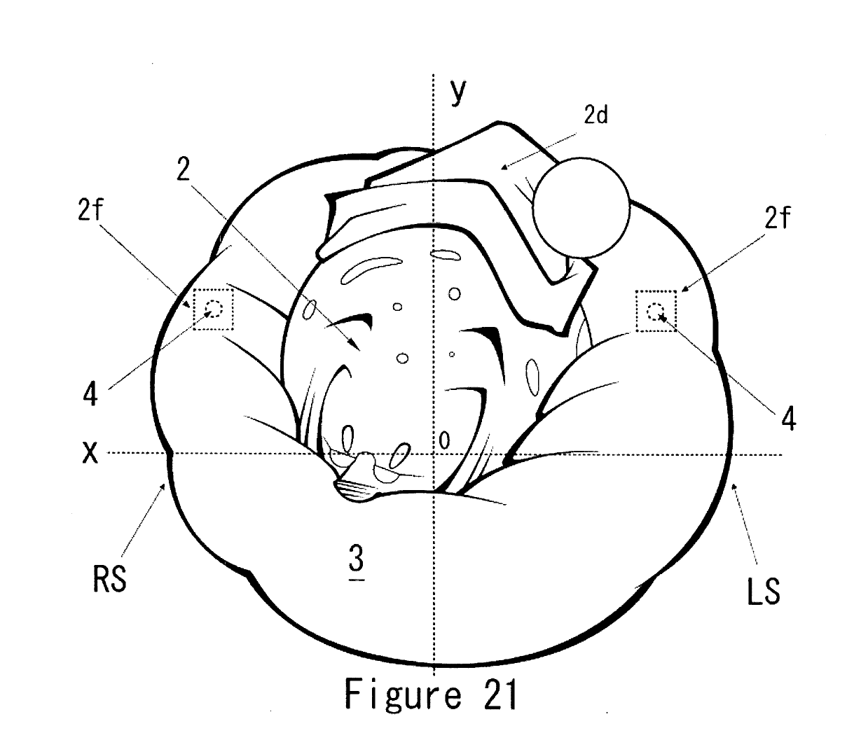

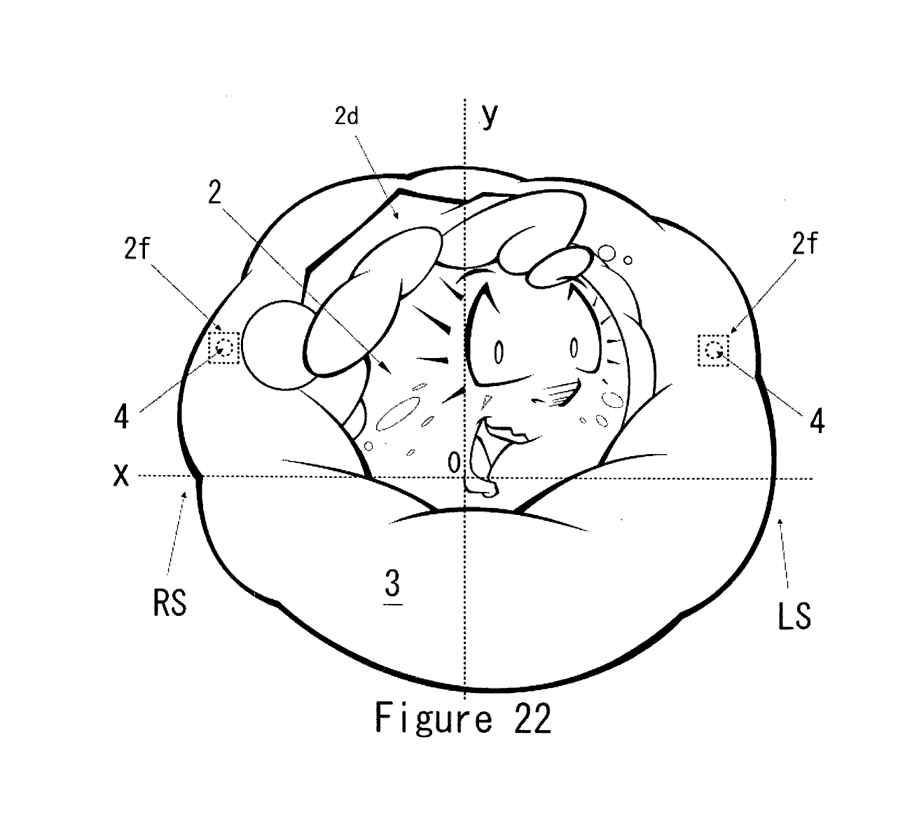

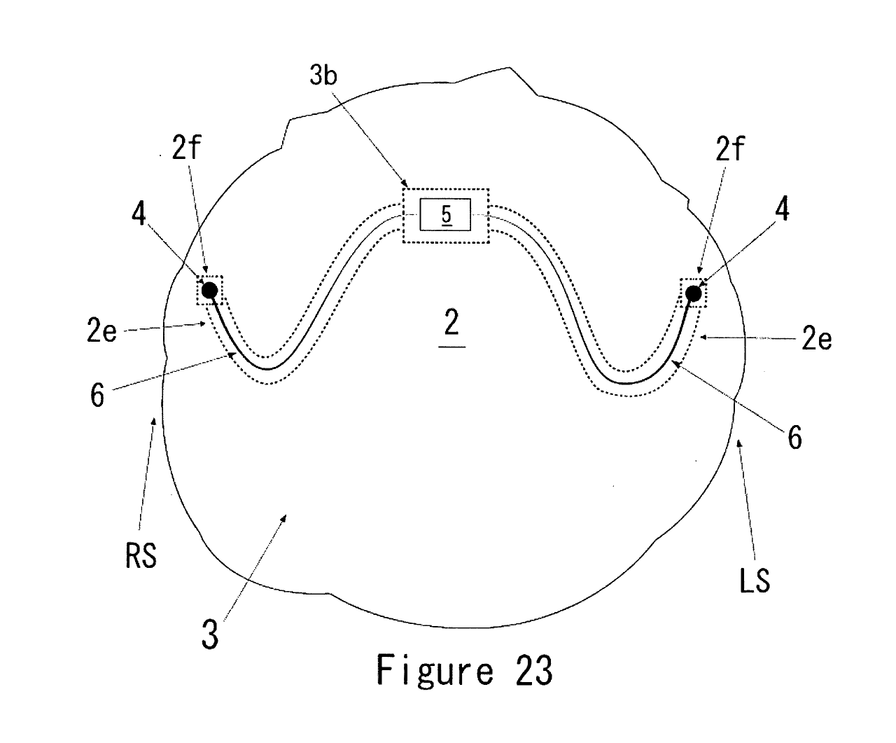

Referring now to FIGS. 19-23, pillows in accordance with an alternate embodiment will now be explained. In view of the similarity between the first and alternate embodiment, the parts of the alternate embodiment that are identical to the parts of the first embodiment will be given the same reference numerals as the parts of the first embodiment. Moreover, the descriptions of the parts of the alternate embodiment that are identical to the parts of the first embodiment may be omitted for the sake of brevity.

FIGS. 19-22 show pillows having speakers 4 embedded in the main cushioning portion 3. The speakers are located on the front side of the first bisecting plane x, the top side of the third bisecting plane z, and on opposite sides of the second bisecting plane y.

The aforementioned control unit that can be used in all embodiments preferably includes a microcomputer with a control program that controls the speakers as discussed above. The control unit can also include other conventional components such as an input interface circuit, an output interface circuit, and storage devices such as a ROM (Read Only Memory) device and a RAM (Random Access Memory) device. The microcomputer of the control unit is programmed to control the speakers. The memory circuit stores processing results and control programs such as ones for operations that are run by the processor circuit. The control unit can be operatively coupled to the speakers in a conventional manner. The internal RAM of the control unit stores statuses of operational flags and various control data. The internal ROM of the control unit stores the data for various operations. The control unit is capable of selectively controlling any of the speakers in accordance with the control program. It will be apparent to those skilled in the art from this disclosure that the precise structure and algorithms for the controller can be any combination of hardware and software that will carry out the functions of the present invention.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a pillow. Accordingly, these terms, as utilized to describe the present invention should be interpreted relative to a pillow as normally used. Finally, terms of degree such as “substantially”, “about,” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A pillow comprising:
a main cushioning portion;
an ornamental display extending from the main cushioning portion;
speaker holding protrusions protruding from the main cushioning portion; and
speakers being arranged in the speaker holding protrusions.

2. The pillow according to claim 1, wherein the speaker holding protrusions extend from the ornamental display.

3. The pillow according to claim 2, wherein the ornamental display is an anthropomorphized inanimate object or objects.

4. The pillow according to claim 3, wherein
the anthropomorphized inanimate object or objects are selected from the group consisting of at least one of a star, sun, moon, and cloud.

5. The pillow according to claim 2, further comprising
an audio device compartment located in an interior of the pillow,
speaker compartment chambers that contain the speakers,
wiring tunnels extending from the audio device compartment to the speaker compartment chambers, and
wires that extend from the speaker to the audio device compartment via the wiring tunnels.

6. The pillow according to claim 5, further comprising
an audio device hatch located on an outer surface of the pillow to allow an audio device to be inserted in the audio device compartment.

7. The pillow according to claim 1, wherein
the speaker holding protrusions extend from the main cushioning portion and are separate from the ornamental display.

8. The pillow according to claim 7, wherein
the ornamental display is an anthropomorphized inanimate object or objects.

9. The pillow according to claim 8, wherein
the anthropomorphized inanimate object or objects are selected from the group consisting of at least one of a star, sun, moon, and cloud.

10. The pillow according to claim 7, further comprising
an audio device compartment located in an interior of the pillow,
speaker compartment chambers that contain the speakers,
wiring tunnels extending from the audio device compartment to the speaker compartment chambers, and
wires that extend from the speaker to the audio device compartment via the wiring tunnels.

11. The pillow according to claim 10, further comprising
an audio device hatch located on an outer surface of the pillow to allow an audio device to be inserted in the audio device compartment.

12. The pillow according to claim 1, wherein
the pillow has a top, bottom, front, rear, left side, and right side, and
the speaker holding protrusions are located on a front side of a first bisecting plane that extends from the top to the bottom and the right side to the left side, and on a top side of a second bisecting plane that extends from the right side to the left side and the front to the rear.

13. The pillow according to claim 12, further comprising
an audio device compartment located in an interior of the pillow,
speaker compartment chambers that contain the speakers,
wiring tunnels extending from the audio device compartment to the speaker compartment chambers, and
wires that extend from the speaker to the audio device compartment via the wiring tunnels.

14. The pillow according to claim 13, further comprising
an audio device hatch located on an outer surface of the pillow to allow an audio device to be inserted in the audio device compartment.

14. The pillow according to claim 1, wherein
the pillow has a top, bottom, front, rear, left side, and right side, and
a first distance extending from a top surface of the ornamental display to a bottom surface of a bottom of the pillow at a front side of the ornamental display is greater than a second distance extending from the top surface of the ornamental display to the bottom surface at a rear side of the ornamental display.

15. The pillow according to claim 14, further comprising
an audio device compartment located in an interior of the pillow,
speaker compartment chambers that contain the speakers,
wiring tunnels extending from the audio device compartment to the speaker compartment chambers, and
wires that extend from the speaker to the audio device compartment via the wiring tunnels.

16. The pillow according to claim 15, further comprising
an audio device hatch located on an outer surface of the pillow to allow an audio device to be inserted in the audio device compartment.

17. A pillow comprising:
a main cushioning portion;
an ornamental display extending from the main cushioning portion; and
speakers being arranged in the main cushioning portion.
